(19) United States
(12) Patent Application Publication
(10) Pub. No.: US 2026/0193055 A1
(43) Pub. Date: Jul. 9, 2026

(54) BRAKING DEVICE FOR BRAKING AN ELEVATOR CAR OF AN ELEVATOR INSTALLATION

(71) Applicant: Inventio AG, Hergiswil (CH)

(72) Inventor: Romeo Lo Jacono, Gravesano (CH)

(21) Appl. No.: 19/132,407

(22) PCT Filed: Nov. 22, 2023
(86) PCT No.: PCT/EP2023/082718

§ 371 Date: May 23, 2025

(30) Foreign Application Priority Data
Dec. 1, 2022 (EP) 22210739.3

(51) Int. Cl. B66B 5/18

(52) U.S. Cl. CPC B66B 5/18

(57) ABSTRACT

An elevator car braking device includes a spring element exerting a spring force on a brake lining, a master unit having a master housing enclosing a displaceable master piston and a master volume filled with brake fluid, and a slave unit having a slave housing enclosing a displaceable slave piston and a slave volume filled with the brake fluid, Increasing the slave volume exerts a counterforce on the slave piston coupled to the brake lining to transmit the counterforce in a direction opposite the spring force. A hydraulic line connects the master volume to the slave volume and a control valve adjustable between blocking and flow positions. The control valve has a first connection to the expansion tank and a second connection to the master volume and/or slave volume, wherein the connections are separated from each other in the blocking position and connected to each other in the flow position.

### FIELD

The present invention relates to a braking device for braking an elevator car of an elevator installation. Furthermore, the invention relates to a method for controlling such a braking device as well as a control device, a computer program and a computer-readable medium for carrying out the method. In addition, the invention relates to a braking arrangement, to a braking system and to an elevator installation.

### BACKGROUND

An elevator installation comprising an elevator car for transporting people and/or objects between different floors of a building can be equipped with a hydraulic brake for braking the elevator car. The brake is usually closed by spring force. This can cause a clearly audible noise in the elevator car, which can affect ride comfort. Disturbing noises can also be caused by a hydraulic pump of the brake.

There may therefore be a need for a braking device that makes it possible to avoid or at least significantly reduce disturbing noises when braking the elevator car.

Furthermore, there may be a need for a method for controlling the braking device, a corresponding control device, a corresponding computer program and a corresponding computer-readable medium.

In addition, there may be a need for a corresponding braking arrangement, a corresponding braking system and a corresponding elevator installation.

### SUMMARY

These needs can be met by the subject-matter of the advantageous embodiments defined in the following description and in the accompanying drawings.

A first aspect of the invention relates to a braking device for braking an elevator car of an elevator installation. In addition to the elevator car, the elevator installation comprises an elevator shaft that connects several floors of a building to one another, and a vertical rail arranged in the elevator shaft. The elevator car is mounted in the elevator shaft in such a way that it can move between the floors. The elevator car can be braked by pressing a brake lining (or a plurality of brake linings) against the rail. The braking device comprises: a spring element which is designed to exert a spring force on the brake lining so that the brake lining is pressed against the rail; a master unit having a master housing and a master piston which is arranged in the master housing so as to be displaced along a master axis and, together with the master housing, encloses a master volume filled with a brake fluid, the size of which volume depends on a position of the master piston in relation to the master axis; a slave unit having a slave housing and a slave piston which is arranged in the slave housing so as to be displaced along a slave axis and, together with the slave housing, encloses a slave volume filled with the brake fluid, the size of which volume depends on a position of the slave piston in relation to the slave axis, wherein by increasing the slave volume, a counterforce can be exerted on the slave piston to compensate for the spring force, wherein the slave piston can be coupled to the brake lining in such a way that the counterforce is transmitted to the brake lining in the opposite direction to the spring force; a hydraulic line which connects the master volume to the slave volume; an actuator which is designed to displace the master piston along the master axis; an expansion tank; a control valve adjustable between a blocking position and a flow position, comprising a first control valve connection which is connected to the expansion tank and a second control valve connection which is connected to the master volume and/or the slave volume, wherein the first control valve connection and the second control valve connection are separated from one another in the blocking position and connected to one another in the flow position. The sum of the master volume and the slave volume is constant provided that the shut-off valve is in the blocking position.

To generate the counterforce, a master cylinder with a linearly displaceable master piston is used in this case instead of a hydraulic pump. This allows disturbing noises, which are usually caused by hydraulic pumps (especially gear pumps) to be avoided. In contrast to such a hydraulic pump, the actuator of the braking device only needs to be activated when the master piston is to be displaced.

The spring force may correspond to a braking force required to brake the elevator car to a standstill. In other words, the spring force can be of such a size that the elevator car is braked to a standstill by the brake lining being pressed against the rail by means of the spring force.

The braking device makes it possible to directly control the contact pressure of the brake lining during normal travel by means of the position of the master piston. For this purpose, the master piston can be displaced correspondingly slowly. Preferably, the master housing has a particularly small cross section in relation to its length. The ratio of length to cross section can, for example, be at least 5 to 1, at least 10 to 1 or at least 20 to 1. This has the advantage that the brake can be closed and/or opened in a controlled and therefore very quiet manner. The length corresponds in particular to the stroke that the master piston can be moved. The cross section is in particular characterized by a diameter.

The hydraulic line allows for pressure equalization between the master volume and the slave volume. If the control valve is in the blocking position, the sum of the master volume and the slave volume is constant. This means, among other things, that the slave volume increases by the same amount as the master volume decreases, and vice versa. To ensure this, the master volume can be connected solely to the hydraulic line, the slave volume can be connected solely to the hydraulic line, and the hydraulic line is connected solely to the check valve in addition to the connections to the slave volume and the master volume.

The control valve allows for pressure equalization in the flow position, regardless of the position of the master piston in the master housing and the position of the slave piston in the slave housing. Expediently, the flow position is a rest position in which the control valve is in a de-energized state. This allows for a very rapid pressure drop in the slave housing in the event of an interruption of the power supply (for example because a switch in the safety circuit of the elevator installation has been opened), i.e. the elevator car is braked correspondingly quickly.

In addition, in conjunction with the expansion tank, the control valve makes it possible to keep the amount of brake fluid in the system constant, which can fluctuate depending on the ambient conditions and/or the tightness of the system.

The slave piston can be coupled to the brake lining, for example, via a rod which is guided through an opening in the slave housing and which can be rigidly connected to the slave piston at one end. For example, the rod can have the same outer diameter as the slave piston or a significantly smaller outer diameter than the slave piston.

The spring element can be arranged at least partially inside and/or at least partially outside the slave housing.

It is possible that the braking device comprises different slave units whose slave volumes are connected to the master volume of the same master unit. The slave volumes can be connected to one another in series. The slave pistons of the various slave units can be couplable to the same brake lining or to different brake linings. The slave units can, for example, be housed in a solid hydraulic block.

A second aspect of the invention relates to a method for controlling the braking device described above and below. The method comprises—if it is detected that the elevator car is to be braked—displacing the master piston in a first direction along the master axis by actuating the actuator so that the master volume increases, and/or setting the control valve to the flow position by actuating the control valve; and/or—if it is detected that the elevator car is no longer intended to be braked—displacing the master piston in a second direction along the master axis by actuating the actuator so that the master volume decreases, and setting the control valve to the blocking position by actuating the control valve.

Moving the master piston in the first direction and setting the control valve to the flow position each independently cause a reduction in pressure in the slave housing, i.e. a reduction in the slave volume, with the result that the counterforce is reduced compared to the spring force.

Conversely, displacing the master piston in the second direction in combination with setting the control valve to the blocking position causes a pressure build-up in the slave housing, i.e. an increase in the slave volume, with the result that the counterforce is increased compared to the spring force.

The method may be implemented by a computer and carried out automatically by a processor, for example of the control device described below.

A third aspect of the invention relates to a control device having a processor that is configured to carry out the method described above and below. The control apparatus may comprise hardware and/or software modules. In addition to the processor, the control apparatus may comprise a memory and a data communication interface for wireless and/or wired data communication with peripheral apparatuses.

It should be noted that features of the methods described above and below may also be features of the control device (and vice versa).

A fourth aspect of the invention relates to a braking arrangement. The braking arrangement comprises at least two braking devices as described above and below. The master units of the various braking devices are the same master unit. Additionally or alternatively, the actuators of the various braking devices are the one and same actuator. Additionally or alternatively, the expansion tanks of the various braking devices are one and the same expansion tank. Such a braking arrangement with redundant braking circuits can be manufactured particularly cheaply.

A fifth aspect of the invention relates to a braking system. The braking system comprises a control device (or a plurality of control devices) as described above and below. Furthermore, the braking system comprises a braking device (or a plurality of braking devices) as described above and below and/or a braking arrangement (or a plurality of braking arrangements) as described above and below.

The braking system may, for example, comprise a separate control device for each braking device, or the same control device for a plurality of braking devices.

A sixth aspect of the invention relates to an elevator installation. The elevator installation comprises: an elevator shaft that connects several floors of a building to one another; a vertical rail (or a plurality of such rails) arranged in the elevator shaft; an elevator car which is mounted in the elevator shaft in such a way that it can be moved between the floors and can be braked by pressing a brake lining (or a plurality of brake linings) against the rail; and the braking system described above and below.

Preferably, at least one slave housing of the braking system is fixed to the elevator car. Alternatively or additionally, at least one slave housing of the braking system can be fixed to a counterweight coupled to the elevator car via at least one suspension means.

The rail or the rails may, for example, be one or more guide rails for guiding the elevator car and/or the counterweight along the elevator shaft. The elevator car can be brakeable, for example, by pressing at least one brake lining against each of the rails.

Further aspects of the invention relate to a computer program and a computer-readable medium on which the computer program is stored.

The computer program comprises commands which cause a processor to carry out the method described above and below when the computer program is executed by the processor.

The computer-readable medium can be a volatile or non-volatile data memory. For example, the computer-readable medium may be a hard disk, a USB storage device (universal serial bus), a RAM (random-access memory), a ROM (read-only memory), a PROM (programmable read-only memory), an EPROM (erasable programmable read-only memory), an EEPROM (electrically erasable programmable read-only memory), a flash memory or a combination of at least two of these examples. The computer-readable medium may also be a data communication network that allows program code to be downloaded (for example via the Internet), or a cloud.

It should be noted that features of the method described above and below may also be features of the computer program and/or of the computer-readable medium (and vice versa).

Embodiments of the invention may be regarded as based on the concepts and findings described below. However, the invention is not limited to these embodiments.

According to one embodiment, the actuator may comprise an electric motor having a drive shaft and a gear for converting rotation of the drive shaft into translation of the master piston. Such an actuator is particularly cheap compared to other types of actuators, such as electromagnetic linear actuators. In addition, such an actuator enables particularly precise adjustment of the master piston in both directions.

According to one embodiment, the gear can be a helical gear and/or self-locking. The helical gear can, for example, comprise a threaded spindle and a spindle nut sitting on the threaded spindle, the position of which nut in the longitudinal direction of the threaded spindle can be changed by turning the threaded spindle in one direction or the other. Accordingly, the master piston can be coupled to the threaded spindle or the spindle nut. Such an actuator can also be referred to as a spindle drive. The self-locking of the gear prevents unwanted adjustment of the master piston as a result of external forces. This means that, for example, the electric motor can be de-energized and the master piston is held by the self-locking function so that the master piston is not adjusted.

However, the actuator can also be designed as an electromagnetic linear actuator, for example in the form of a lift elevatoring magnet.

According to one embodiment, the braking device may further comprise a check valve having a first check valve connection that is connected to the compensation tank and a second check valve connection that is connected to the master volume. The check valve can be designed so that the brake fluid can only flow from the first check valve connection to the second check valve connection. This has the effect that when the master volume is increased, a certain amount of brake fluid can flow from the expansion tank to the master volume. In particular, this does not depend on whether the control valve is in the blocking position or the flow position. Such a check valve can also be referred to as a non-return valve.

According to one embodiment, the second control valve connection can be connected to the hydraulic line. In this way, the second control valve connection is connected to both the master volume as well as to the slave volume. However, the second control valve connection can also be connected to the master volume and the slave volume without the detour through the hydraulic line.

According to one embodiment, the method may further comprise: determining a maximum travel which is the maximum the master piston can move in a direction along the master axis; determining whether the maximum travel exceeds an allowable travel; detecting that the brake lining has exceeded a wear limit if the maximum travel exceeds the allowable travel. The maximum travel usually depends on the thickness of the brake lining. For example, the thinner the brake lining, the longer the maximum travel may be. Based on the maximum travel, it is possible to determine whether the brake lining has a required minimum thickness. The allowable travel may correspond to the thickness of the brake lining in a new state or may be smaller than such a thickness by a predefined value.

According to one embodiment, the method may further comprise a step in which a pressure value is received that indicates the pressure with which the brake lining is pressed against the rail. The pressure value may have been provided using a suitable pressure sensor. In this case, the actuator and/or the control valve can be actuated using the pressure value. This makes it possible, for example, to actuate the actuator so that the pressure value approaches a certain target value.

According to one embodiment, the method may further comprise a step in which a distance value is received that indicates a (vertical) distance between the current position of the elevator car and a desired position in which the elevator car should stop. The distance value may have been provided using a suitable distance sensor. This makes it possible, for example, to brake the elevator car using the braking device (in addition to a braking effect generated by a drive motor of the elevator installation) before the elevator car reaches the desired position.

Embodiments of the invention will be described below with reference to the accompanying drawings. However, the invention is neither limited to the drawings nor to the following description.

### DESCRIPTION OF THE DRAWINGS

FIG. 1 shows an elevator system according to one embodiment of the invention.

FIG. 2 shows a braking system according to one embodiment of the invention, having two slave units and two master units.

FIG. 3 shows a braking system according to one embodiment of the invention having two slave units and one master unit.

The drawings are purely schematic and are not to scale. Where the same reference signs are used in different drawings, these reference signs denote identical or equivalent features.

### DETAILED DESCRIPTION

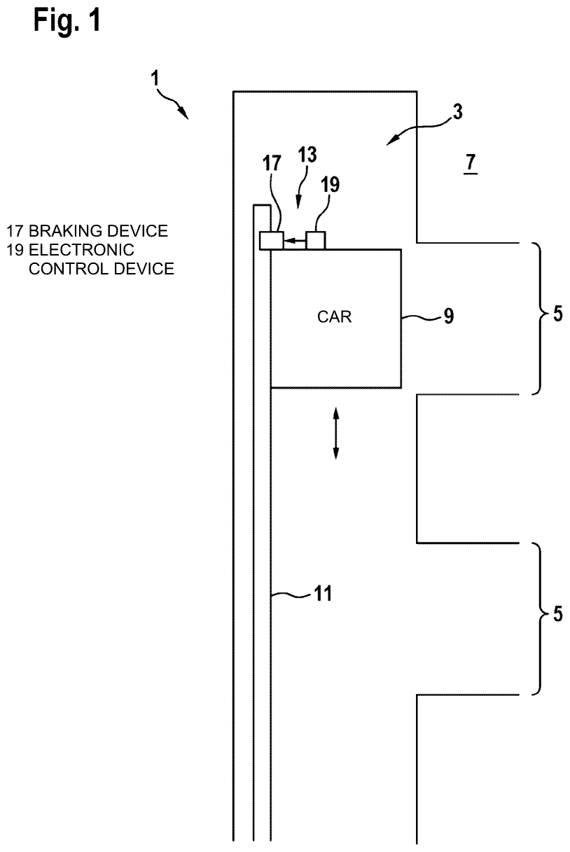

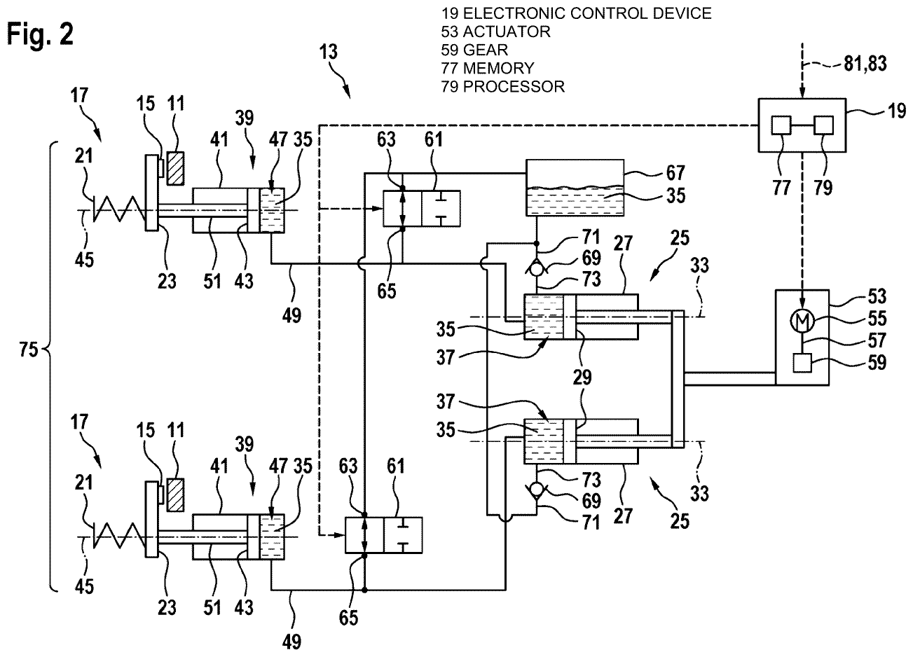

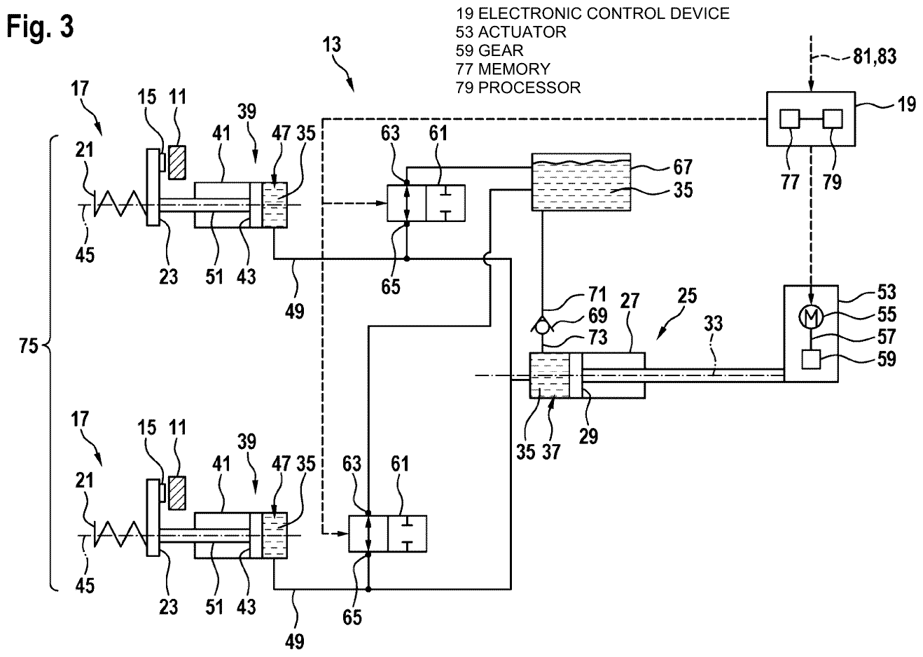

FIG. 1 shows an elevator installation 1 having an elevator shaft 3, which connects several floors 5 of a building 7 to one another. An elevator car 9 is mounted in the elevator shaft 3 in such a way that it can be moved between the floors 5 by means of a suitable drive. The elevator installation 1 further comprises a vertical rail 11 arranged in the elevator shaft 3, here a guide rail for guiding the elevator car 9 along the elevator shaft 3, and a braking system 13 which is designed to brake the elevator car 9 by pressing a brake lining 15 (see FIG. 2 and FIG. 3), or by simultaneously pressing a plurality of such brake linings 15, against the rail 11 (or against a plurality of rails 11) and/or to hold it at a standstill.

To control the contact pressure with which the brake lining 15 is pressed against the rail 11, the braking system 13 comprises a braking device 17 and a preferably electronic control device 19 for controlling the braking device 17. For safety reasons, the braking system 13 may also comprise a plurality of redundant braking devices 17 (see FIG. 2 and FIG. 3).

As shown in FIG. 2 and FIG. 3, the braking device 17 comprises a spring element 21 which is designed to exert a spring force on the brake lining 15 so that the brake lining 15 is pressed against the rail 11. In this example, the brake lining 15 is attached to a first side of a plate-shaped carrier 23, wherein the spring element 21 presses against a second side of the carrier 23 that is opposite the first side, thus exerting the spring force on the brake lining 15 via the carrier 23.

Furthermore, the braking device 17 comprises a master unit 25 having a master housing 27 and a master piston 29 which is arranged in the master housing 27 so as to be displaced along a master axis 33 and, together with the master housing 27, encloses a master volume 37 filled with a brake fluid 35, the size of which volume depends on a position of the master piston 29 in relation to the master axis 33, as well as a slave unit 39 having a slave housing 41 and a slave piston 43 which is arranged in the slave housing 41 so as to be displaced along a slave axis 45 and, together with the slave housing 41, encloses a slave volume 47 filled with the brake fluid 35, the size of which volume depends on a position of the slave piston 43 in relation to the slave axis 45.

The master volume 37 and the slave volume 47 are connected to one another via a hydraulic line 49 so that pressure equalization between the master volume 37 and the slave volume 47 is possible. This has the effect that the slave volume 47 increases when the master volume 37 decreases, and vice versa.

By increasing the slave volume 47, a counterforce is exerted on the slave piston 43 to compensate for the spring force. The slave piston 43 is coupled to the brake lining 15 in such a way that the counterforce is transmitted to the brake lining 15 in the opposite direction to the spring force. This has the effect of reducing the contact pressure of the brake lining 15.

In this example, the slave piston 43 is coupled to the carrier 23 via a rod 51 guided through an opening in the slave housing 41. The rod 51 is rigidly connected to the slave piston 43 at one end and can thus be displaced together with the slave piston 43. By increasing the slave volume 47, the rod 51 presses against the carrier 23 in the opposite direction to the spring force, thereby reducing the contact pressure of the brake lining 15.

In addition, the braking device 17 comprises an actuator 53 which is designed to displace the master piston 29 along the master axis 33. In this example, the actuator 53 comprises an electric motor 55 having a drive shaft 57 and a gear 59 that is coupled to the drive shaft 57, which is designed to convert rotation of the drive shaft 57 into translation of the master piston 29. The gear 59 can be a helical gear, preferably with self-locking. However, an actuator 53 in the form of an electromagnetic linear actuator, for example a lift elevatoring magnet or a linear motor, is also possible.

In order to be able to brake the elevator car 9 quickly enough in an emergency, the braking device 17 comprises a control valve 61 that can be adjusted between a blocking position and a flow position and has a first control valve connection 63 and a second control valve connection 65 which are separated from one another in the blocking position and connected to one another in the flow position. In this example, the first control valve connection 63 is connected to an expansion tank 67, wherein the second control valve connection 65 is connected to the hydraulic line 49 and in this way to both the master volume 37 and to the slave volume 47. However, the second control valve connection 65 can also be connected solely to the master volume 37 or solely to the slave volume 47 if the master volume 37 and the slave volume 47 are connected to one another via the hydraulic line 49 for pressure equalization.

The braking device 17 may additionally comprise a check valve 69 having a first check valve connection 71 and a second check valve connection 73. In this case, the check valve 69 can be connected—parallel to the control valve 61—to the expansion tank 67 via the first check valve connection 71 and to the master volume 37 via the second check valve connection 73. The check valve 69 is designed such that the brake fluid 35 can flow from the first check valve connection 71 to the second check valve connection 73, but not in the opposite direction. This has the effect that when the pressure in the master housing 27 drops, a certain amount of the brake fluid 35 can flow from the expansion tank 67 into the master housing 27, and when the pressure builds up in the master housing 27, the brake fluid 35 can only leave the master housing 27 via the hydraulic line 49.

In the example shown in FIG. 2, the braking system 13 comprises a braking arrangement 75 made up of two identical braking devices 17, each having a master unit 25 and a slave unit 39. The two master pistons 29 are each coupled to the same actuator 53 in such a way that they can be simultaneously displaced along their respective master axes 33 by the actuator 53. In addition, the two control valves 61 and the two check valves 69 are connected to the same expansion tank 67.

In contrast to FIG. 2, each of the two braking devices 17 of the braking arrangement 75 shown in FIG. 3 do not have their own master unit 25, but rather the same master unit. The two hydraulic lines 49 can be connected to the master housing 27 via separate connections or, as shown in FIG. 3, via the same connection. In the latter case, the two hydraulic lines 49 form a common hydraulic line 49. Unlike that shown in FIG. 3, the common hydraulic line 49 can also be connected to the expansion tank 67 via only a single control valve 61 instead of via two control valves 61 in order to achieve the same effect as with two control valves 61.

The spring elements 21 of the various braking devices 17 can be designed to exert their spring force on the same brake lining 15 or on different brake linings 15.

The spring elements 21 of the various braking devices 17 may also be the same spring element 21.

The slave pistons 43 of the various braking devices 17 can each be couplable to the same brake lining 15 or to different brake linings 15.

Preferably, the two braking devices 17 are not coupled to the same rail 11, but to different rails 11, for example they may each be coupled to one of two guide rails for guiding the elevator car 9 along the elevator shaft 3.

The two braking devices 17 can also form two completely independent, i.e. completely redundant, braking circuits.

The actuator 53 and the control valves 61 are controlled by the control device 19. In this example, the control device 19 comprises a memory 77 and a processor 79 that is configured to carry out the method below for controlling the braking devices 17 by executing a computer program stored in the memory 77.

If the control device 19 detects that the elevator car 9 is to be braked, it actuates the actuator 53 such that the particular master piston 29 is displaced in a first direction along the master axis 33, whereby the particular master volume 37 increases. The master piston 29 is preferably adjusted so as to prevent the brake lining 15 from striking the rail 11 with a noise that may be perceived in the elevator car 9 as unpleasant. In particular in an emergency when the braking effect must be applied suddenly, the control device 19 actuates the particular control valve 61 in addition to, or as an alternative to, the actuator 53 so as to place it in the flow position. This results in a particularly rapid reduction in pressure in the particular slave housing 41, and therefore the particular brake lining 15 is suddenly pressed against the particular rail 11 by the spring force required for braking, and the elevator car 9 is braked accordingly quickly.

In FIG. 2 and FIG. 3, the control valve 61 is shown in the flow position in each case. This corresponds to the emergency situation mentioned above. The slave volumes 47 are thereby suddenly emptied into the expansion tank 67. The spring elements 21 press the brake lining 15 shortly thereafter against the rail 11.

However, if the control device 19 detects that the elevator car 9 is no longer intended to be braked, it actuates the particular control valve 61 so that is moves into the blocking position. It then actuates the actuator 53 in such a way that the particular master piston 29 is displaced in a second direction opposite the first direction, whereby the particular master volume 37 is reduced, and pressure builds up in the particular slave housing 41. Accordingly, the contact pressure of the particular brake lining 15 is reduced.

If the control device 19 actuated the particular control valve 61 in order to empty the slave volume 47, the control device 19 initially actuates the actuator 53 in such a way that the particular master piston 29 is displaced in a first direction in order to sufficiently increase the master volume 37 from the expansion tank 67 to be able to fill the slave volume 47 in one movement.

The control device 19 can additionally receive a pressure value 81 indicating the contact pressure and provided by a particular pressure sensor and use it to actuate the actuator 53 and/or the particular control valve 61, for example to control the contact pressure.

Additionally or alternatively, the control device 19 can receive a distance value 83 which indicates a distance between a current position of the elevator car 9 and a desired position in which the elevator car 9 should stop. The distance value 83 can then be used to actuate the actuator 53 and/or the particular control valve 61, for example to support motor braking.

The pressure value 81 or the distance value 83 or the pressure value 81 and the distance value 83 can each be received over several consecutive time intervals during operation of the elevator installation 1, i.e. updated with a certain frequency.

With the aid of the braking device 17 described above, the thickness of the brake lining 15 can also be automatically monitored. For this purpose, the control device 19 determines a maximum travel by which the master piston 29 can be maximally displaced in a direction along the master axis 33 by correspondingly actuating the actuator 53. The maximum travel determined in this way is then compared with an allowable travel stored, for example, in the memory 77, which corresponds to a minimum thickness of the brake lining 15. If the maximum travel exceeds the allowable travel, the control device 19 detects that the brake lining 15 is too thin. In this case, the control device 19 generates, for example, a corresponding message that prompts a technician to replace the brake lining 15 in question.

Finally, it should be noted that terms such as “having,” “comprising,” “including,” “with,” etc. do not exclude other elements or steps, and indefinite articles such as “a” or “an” do not exclude a plurality. Furthermore, it should be noted that features or steps that are described with reference to one of the above embodiments may also be used in combination with features or steps that are described with reference to other of the above embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A braking device for braking an elevator car of an elevator installation, the elevator installation including an elevator shaft connecting several floors of a building to one another, a vertical rail arranged in the elevator shaft, the elevator car being moveable in the elevator shaft between the floors, and the elevator car having the braking device pressing a brake lining against the rail to brake the elevator car, the braking device comprising:
a spring element exerting a spring force on the brake lining pressing the brake lining against the rail;
a master unit having a master housing and a master piston arranged in the master housing, the master piston being displaceable along a master axis and, together with the master housing, enclosing a master volume filled with a first portion of a brake fluid, a size of the master volume depending on a position of the master piston along the master axis;
a slave unit having a slave housing and a slave piston arranged in the slave housing, the slave piston being displaceable along a slave axis and, together with the slave housing, enclosing a slave volume filled with a second portion the brake fluid, a size of the slave volume depending on a position of the slave piston along the slave axis, wherein a counterforce compensating for the spring force is exerted on the slave piston by increasing the slave volume, the slave piston being coupled to the brake lining such that the counterforce is transmitted to the brake lining in a direction opposite to the spring force;
a hydraulic line connecting the master volume to the slave volume;
an actuator adapted to displace the master piston along the master axis;
an expansion tank containing a third portion of the brake fluid;
a control valve adjustable between a blocking position and a flow position, the control valve having a first control valve connection connected to the expansion tank and a second control valve connection connected to the master volume and/or the slave volume, the first control valve connection and the second control valve connection being separated in the blocking position and connected together in the flow position, wherein a sum of the master volume and the slave volume is constant when the control valve is in the blocking position.

17. The braking device according to claim 16 wherein the actuator includes an electric motor having a drive shaft and a gear, the gear converting rotation of the drive shaft into displacement of the master piston along the master axis.

18. The braking device according to claim 17 wherein the gear is a helical gear and/or a self-locking gear.

19. The braking device according to claim 16 including a check valve having a first check valve connection connected to the expansion tank and a second check valve connection connected to the master volume, wherein the brake fluid only flows from the first check valve connection to the second check valve connection.

20. The braking device according to claim 16 wherein the second control valve connection is connected to the hydraulic line.

21. A braking arrangement comprising:
two braking devices according to claim 16;
wherein the master units of the braking devices are a single master unit; and/or
wherein the actuators of the braking devices are a single actuator; and/or
wherein the expansion tanks of the braking devices are a single expansion tank.

22. A method for controlling braking of an elevator car, the elevator car having the braking device according to claim 16, the method comprising steps of:
operating the braking device to control a contact pressure applied by the brake lining to the rail;
detecting that the elevator car is to be braked and displacing the master piston in a first direction along the master axis by actuating the actuator to increase the master volume and/or setting the control valve to the flow position by actuating the control valve; and/or
detecting that the elevator car no longer is to be braked and displacing the master piston in a second direction along the master axis by actuating the actuator to reduce the master volume, and setting the control valve to the blocking position by actuating the control valve.

23. The method according to claim 22 further comprising:
determining a maximum travel of the master piston in a direction along the master axis;
determining whether the maximum travel exceeds an allowable travel; and
detecting that the brake lining has exceeded a wear limit when the maximum travel exceeds the allowable travel.

24. The method according to claim 22 further comprising:
receiving a pressure value indicating the contact pressure with which the brake lining is pressed against the rail; and
actuating the actuator and/or the control valve based upon the pressure value.

25. The method according to claim 22 further comprising:
receiving a distance value indicating a distance between a current position of the elevator car in the elevator and a desired position at which the elevator car is to stop; and
actuating the actuator and/or the control valve based upon the distance value.

26. A computer program product comprising commands that, when executed by a processor, cause the processor to perform the method according to claim 22.

27. A non-transitory computer-readable medium on which the computer program commands according to claim 26 are stored.

28. A control device comprising a processor adapted to operate the braking device to perform the method according to claim 22.

29. A braking system comprising:
the braking device according to claim 16;
a control device connected to and operating the braking device;
wherein the control device detects that the elevator car is to be braked and displaces the master piston in a first direction along the master axis by actuating the actuator to increase the master volume and/or setting the control valve to the flow position by actuating the control valve; and/or
wherein the control device detects that the elevator car no longer is to be braked and displaces the master piston in a second direction along the master axis by actuating the actuator to reduce the master volume, and setting the control valve to the blocking position by actuating the control valve.

30. The braking system according to claim 29 including another of the braking device connected to and controlled by the control device.

31. The braking system according to claim 30:
wherein the master units of the braking devices are a single master unit; and/or
wherein the actuators of the braking devices are a single actuator; and/or
wherein the expansion tanks of the braking devices are a single expansion tank.

32. A elevator installation comprising:
an elevator shaft connecting several floors of a building to one another;
a vertical rail arranged in the elevator shaft;
an elevator car moveable in the elevator shaft between the floors, the elevator car having a brake lining adapted to press against the rail to brake the elevator car; and
the braking system according to claim 29 controlling the pressing of the brake lining against the rail.
